(19) United States
(12) Patent Application Publication
(10) Pub. No.: US 2011/0224108 A1
(43) Pub. Date: Sep. 15, 2011

(54) WATER-BASED POLYMER DRILLING FLUID AND METHOD OF USE

(76) Inventor: John Ewanek, Calgary (CA)

(21) Appl. No.: 13/113,645

(22) Filed: May 23, 2011

Related U.S. Application Data
(62) Division of application No. 12/090,016, filed on Apr. 11, 2008.

(51) Int. Cl. C09K 8/12; C08F 220/56

(52) U.S. Cl. 507/120; 526/307.6

(57) ABSTRACT

A water-based drilling fluid comprises a polymer which is a non-ionic polymer or an anionic polymer. The polymer can be a polyaerylamide. The fluid is used for drilling subterranean formations containing heavy crude oil and bitumen-rich oil sands, and may comprise additional fluid components.

### FIELD OF THE INVENTION

The invention relates generally to water-based polymer drilling fluids.

### BACKGROUND OF THE INVENTION

A major problem when drilling subterranean formations containing heavy crude oil and bitumen-rich oil sands is that the bitumen or heavy oil accretes or sticks to drilling components resulting for example in tar-like materials being stuck to tubulars or solid control equipments and surface fluid handling equipments. Bitumen can also cause foaming of surfactants. This situation forces the operators to frequently stop the drilling process in order to remove the accumulated bitumen or to get the foaming under control, resulting in time waste and thus decrease in productivity.

Various solutions have been proposed in the prior art including modifications to the composition of conventional drilling fluids to prevent the accretion. Such modifications are outlined for example in published PCT applications WO 03/008758 of Mckenzie et al., WO 2004/050790 of Wu et al., and WO 2004/050791 of Ewanek et al. In particular, Ewanek et al. disclose an aqueous drilling fluid comprising a cationic polyacrylamide (CIPA) that encapsulates the bitumen or heavy oil, preventing its accretion to drilling components.

While the drilling fluids known in the art are useful, there remain ongoing problems associated with their use, in particular regarding the viscosity of the fluid. A preferred drilling fluid would have a viscosity that is suitable for limiting cationic-anionic attraction between the cationic bitumen encapsulator and the anionic fluid viscosifier, thus avoiding flocculation. Also, it has been noted that cationic bitumen encapsulators are difficult to mix with water due to the fact that their manufacturing process does not allow for a suitable additive dispersion effect on the polymer.

There is therefore still a need for more simple, efficient and cost effective solutions to this problem.

### SUMMARY OF THE INVENTION

The inventors have discovered that using a water-based drilling fluid comprising a non-ionic or anionic polymer significantly reduces accretion of bitumen or heavy oil to drilling components during a drilling process. Of particular interest are non-ionic and anionic polyacrylamides. They may be used in a pH medium of between about 1 to about 13.

The invention thus provides according to an aspect for a water-based drilling fluid comprising a polymer chosen from the group comprising anionic and non-ionic polymers.

The polymer may be a non-ionic polymer or an anionic polyacrylamide. The non-ionic polyacrylamide may have the general formula:

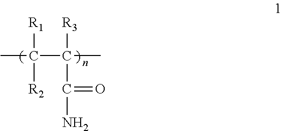

wherein:

R₁, R₂ and R₃ are each independently selected from H and a C₁ to C₆ linear, branched, saturated, unsaturated or cyclic alkyl group optionally containing at least one heteroatom; and

n ranges from 10,000 to 1,000,000.

And the anionic polyacrylamide may have the general formula:

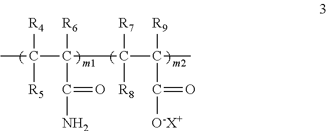

wherein:

R₄ to R₉ are each independently selected from H and a C₁ to C₆ linear, branched, saturated, unsaturated or cyclic alkyl group optionally containing at least one heteroatom;

m1 and m2 each independently range from 10,000 to 1,000,000; and

X⁺ is selected from the group consisting of Li⁺, Na⁺, K⁺ and a quaternary ammonium ion.

The non-ionic polyacrylamide and the anionic polyacrylamide may respectively have formulae 2 and 4 below.

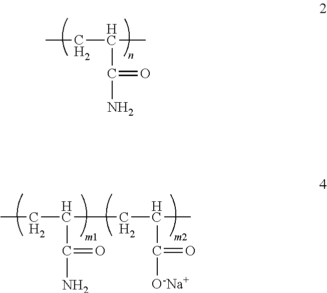

The pH of the water-based drilling fluid may be between about 1 to about 13 or between about 1 to about 7. The anionicity of the anionic polyacrylamide may be between 0 to 100% or less than about 1%. The molecular weight of the polyacrylmide may be between about 1 to about 30 million, or between about 1 to about 15 million, or between about 8 to about 10 million. The non-ionic polyacrylamide may be NF 201™ or NE 823™ or equivalent polymers from other manufacturers; and the anionic polyacrylamide may be AF 203™, AF 204™, AF 204RD™, AF 207™, AF 207RD™, AF 247RD™, AF 250™, AF 211™, AF 215™, AF 251™, AF 308™, AF 308HH™, DF 2020-D™, NE 823™, AE 833™, AE 843™, AE 853™, AE 856™, AD 855™, AD 859™, AE 874™, AE 876™, DF 2010™, DF 2020™ or equivalent polymers from other manufacturers as outlined in Table 7.

In another aspect, the water-based drilling fluid according to the invention may be used together with an organic acid, an inorganic acid, an organic salt, and inorganic salt or a mixture of these.

In yet another aspect, water-based drilling fluid according to the invention may comprise fluid additives, viscosifiers, fluid loss additives, weighting materials, clay formation control agents, bactericides, defoamers, lost circulation materials, bridging agents or mixtures thereof.

In a further aspect, the invention provides a method of drilling subterranean formations containing heavy crude oil and bitumen-rich oil sands, the method comprising using a water-based drilling fluid comprising a polymer chosen from the group comprising anionic and non-ionic polymers.

### DESCRIPTION OF THE DRAWINGS

FIGS. 1 and 2 are photographs showing shaker screens after treatment with the drilling fluid according to the invention.

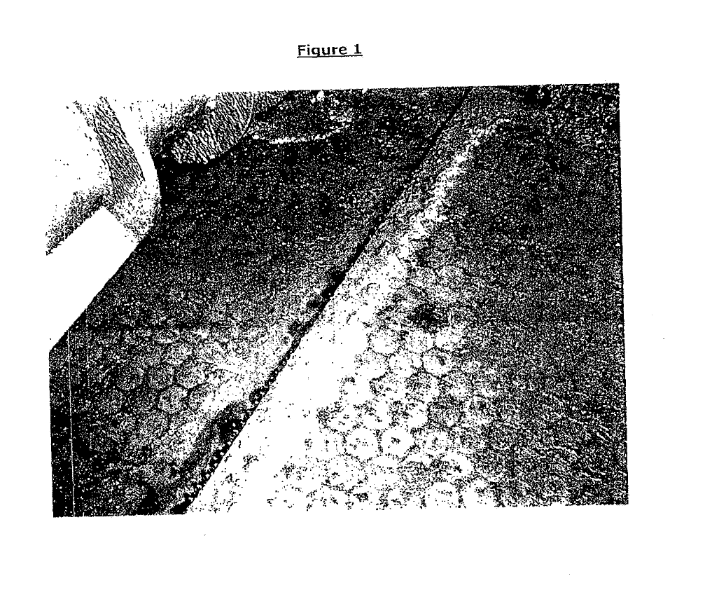

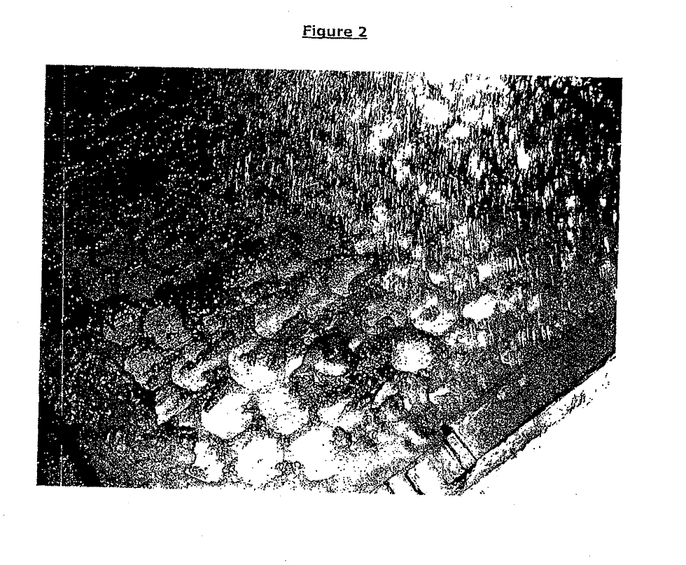

### DETAILED DESCRIPTION OF THE INVENTION

The invention provides according to one aspect, for a water-based drilling fluid that comprises a non-ionic or anionic polymer. The polymer may be a polyacrylamide of general formula 1 (NIPA) or 3 (AIPA), and obtained respectively according to the following chemical reactions:

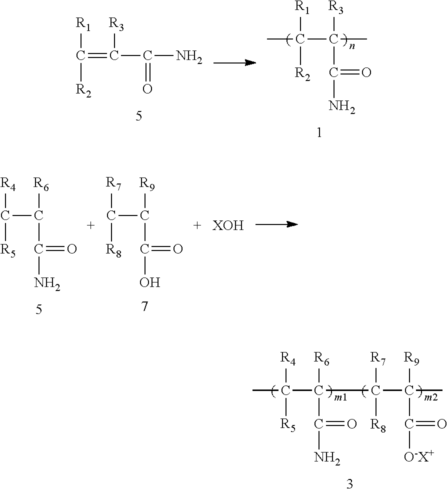

The non-ionic polyacrylamide 1 is a homopolymer of an acrylamide 5. Such polymer is termed “non-ionic” although slight hydrolysis of the amide group may yield a polymer of slight anionic nature, generally with an anionicity of less than 1%.

The anionic polyacrylamide 3 is obtained by copolymerisation of an acrylamide 5 with an acrylic acid 7 in the presence of a base. The anionicity of the anionic polyacrylamide may vary from 1 to 100% depending on the ratio of the monomers 5 and 7.

The following reaction schemes outlined the synthesis of polyacrylamide 2 and sodium acrylate polyacrylamide 4.

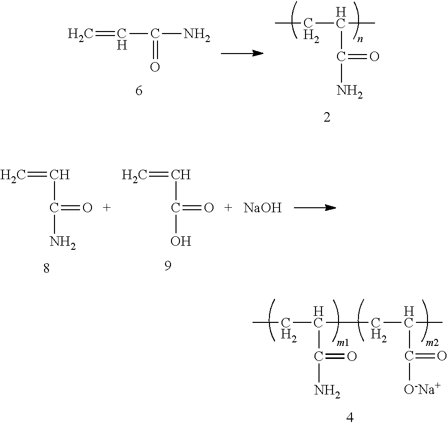

Experiments were performed in order to establish the efficiency of the drilling fluid of the invention. The experiments were carried out according to the standards outlined in published PCT application WO 2004/050791 of Ewanek et al. Polymers used in the experiments are produced and sold by Hychemri™. Table 7 describes the characteristics of polymers used in the Examples or otherwise available from Hychem™. The experiments were generally conducted at a concentration of about 3 kg/m³ and at a pH of less than about 7. Sulphamic acid was used to adjust the pH.

The drilling fluid of the invention can be used in just water in terms known in the art as “Floc Water”. It may also comprise one or more components including know drilling fluid additives, viscosifiers, fluid loss additives, weighting materials, clay formation control agents, bactericides, defoamers, lost circulation materials or bridging agents. Such components are generally known in the art.

Examples of fluid loss additives include but are not limited to modified starches, polyanionic celluloses (PACs), ignites and modified carboxymethyl cellulose. Weighting materials are generally inert, high density particulate solid materials and include but are not limited to carbonate calcium, barite, hematite, iron oxide and magnesium carbonate. Bridging agents can be used in the drilling fluid in order to seal off the pores of subterranean formation that are contacted by the fluid. Examples of bridging agents include but are not limited to calcium carbonate, polymers, fibrous material and hydrocarbon materials. Clay formation control agents include but are not limited to “ClayCenturion”. Examples of defoamers include but are not limited to silicone-based defoamers and alcohol-based defoamers such as 2-ethylhexanol. Bactericides that can be used with fluid according to the invention include but are not limited to glutaraldehyde, bleach and BNP.

### Example 1

Table 1 shows the experiment conditions of a screening study conducted using some non-ionic and anionic polyacrylamides. The bar and cell used in the experiments were perfectly clean when NF 201™, a non-ionic polyacrylamide, was used at a pH of about 2.5. The results obtained for each of the samples are outlined below.

Sample 1: water brown in colour and slightly oily; bar fairly clean, however slightly not perfect.

Sample 2: water brown in colour and slightly oily; bar fairly clean, however cell is clean.

Sample 3: water clear; bar and cell clean.

Sample 4: water clear; bar sticking covered with a large amount of bitumen, however cell is clean.

Sample 5: water dirty; bar sticking covered with bitumen sticking to the cell.

### Example 2

In another set of experiments, AF 204RD™ and NF 201™ were used at various concentrations and pH. AF 204RD™ is an anionic polymer, partially hydrolyzed polyacrylamide (PHPA), and NF 201™ is an anionic polyacrylamide. Table 2 shows the experiment conditions. The results obtained for each of the samples are outlined below.

Sample 1: water slight oil sheen on top, water is fairly clear (slight brown but almost clear); slight bar sticking, no cell sticking and no real sticking to the hands when solids are handled.

Sample 2: water slightly brown, oil dispersed through out the liquid; bar sticking, very slight cell sticking and sticking to the hands when solids are handled.

Sample 3: water was clear but brown probably due to disperser solids, minute sheen on top, can see through liquid; no bar sticking, no cell sticking, can touch and handle solids without sticking.

Sample 4; water was clear but brown probably due to dispersion of solids, minute sheen on top, can see through liquid; no bar sticking, no cell sticking, can touch and handle solids without sticking.

Sample 5: water was clear; no bar sticking, no cell sticking, can touch and handle solids without sticking.

### Example 3

Experiments were conducted in order to show the effectiveness of NF 201™ on bitumen accretion, and also to show the benefits on viscosity of adding kelzan XCD™, a xanthan gum. Experiment conditions are shown in Table 3. The results obtained for each of the samples are outlined below.

Sample 1: water clear; no sticking bar.

Sample 2: slight bar sticking easily rinsed.

Sample 3: water was clear; no sticking anywhere.

It can be seen that NF 201™ used together with kelzan XCD™ not only provided a clean bar and cell, but also provided stable viscosity,

### Example 4

Experiments were also conducted in order to determine a minimum concentration required for the non-ionic polyacrylamide when used together with kelzan XCD™. In addition, a cationic polyacrylamide, was used in order to compare the efficiencies of the two types of polymers. The experiment conditions are shown in Table 4. The results obtained for each of the samples are outlined below.

Sample 1: viscosity increased after hot rolling AHR indicating no detrimental effect to the xanthan gum from NF 201™.

Sample 2: fluid had slight sheen, fluid was brown in colour probably because bitumen solids dispersed through out the fluid due to mechanical erosion because of the prolonged roll; no bar sticking, slight cell sticking easily rinsed of, cell sticking most likely mechanical due to prolonged roll; sand is visible through out the fluid; no free solids remained dispersed through out the fluid.

Sample 3: very similar to sample 2; a little more fine sand stuck to the cell, no bitumen and easily rubbed off, a little more sticky than in sample 2.

Sample 4: water was fairly clear and brown in colour slight sheen; slight sticking to bar but easily rinsed off with water, cell was clean; solids looked non dispersed and original indicating encapsulation.

Sample 5: water was darker brown with a slight oil sheen on top, sheen was slightly less than in sample 4; no cell sticking, but bar had sticking that required significant cleaning; sand appears to be dispersed at the bottom, there was no sand/bitumen left after the roll.

It can be seen that results obtained with the non-ionic polyacrylamides were slightly better in bitumen accretion and superior in viscosity characteristics and ease of mixing, comparing to results obtained with the cationic polyacrylamide.

### Example 5

Experiments were conducted using NF 201™ to assess the effect of pH on the activity of the polymer. The pH of the fluid was lowered using sulphamic acid, and increased using caustic soda. Table 5 shows the experiment conditions, The results obtained for each of the samples are outlined below.

Sample 1: sticking on bar, slight sticking to cell; fluid brown and not very clear.

Sample 2: very slight sticking to the bar, sticking is on the top of the bar (diameter), very little sticking to the ageing cell; liquid brown in colour and not as clear as in others samples.

Sample 3: liquid dark brown in colour; bar and cell have severe sticking.

Sample 4: water clear amber; bar and cell perfectly clean.

In can be seen that better results are obtained at a low pH. Also, pH may play a very important role in the anti-accretion behavior of the NF 201™.

### Example 6

Experiments were carried out in order to assess whether the low pH altered the NF 201™ or altered the nature of the bitumen. In the experiment the pH was increased to a basic pH, and an inorganic mono valence cationic salt was added (one salt was mono valence anion and the other salt was di-valence anion in order to isolate results). An ammonium organic salt was also added. Table 6 shows the experiment conditions. The results obtained for each of the samples are outlined below.

Sample 1: water clear amber; bar and cell perfectly clean; bitumen appears to be perfectly encapsulated.

Sample 2: water clear amber; bar and cell perfectly clean; bitumen appears to be perfectly encapsulated.

Sample 3: water clear amber; bar and cell perfectly clean; bitumen appears to be perfectly encapsulated

The positive effect of mono valence cations as well as the organic ammonium salts can be seen. This shows that polymer alteration may not necessarily occur at low pH. The results of these experiments contribute to illustrate to the hypothesis that bitumen alteration may occur through the neutralization of the many negatively charged surfactants that are present in the bitumen by the positive charges of the cations and/or the positive charge of the organic salt. This neutralization of the negatively charged surfactants present in the bitumen favors attraction forces between the NF 201™ and the bitumen, thus allowing the encapsulation process to occur.

### Example 7

A field trial in Northern Alberta, Canada on three wells in which bitumen formation was penetrated, was carried out. The three wells were penetrated and bitumen was encountered.

When a drilling fluid is used in the field, the fluid composition is constantly changing due to a large number of variables affecting the drilling fluid such as drilling operations, skill of rig personnel in carrying out additions of additives and rig equipment maintenance, formations drilled and types of solids entering the fluid, water sources, geological problems such as lost circulations and many more variables that affect the fluid. Thus the exact concentration of the fluid at all times may not be known. A series of basic field fluid tests are used to maintain the drilling fluid properties in a given range.

On this field trial the following additives were used: xanthan gum for viscosity control; sulphamic acid for pH control; modified starch, calcium carbonate and/or PAC for fluid loss control; “ClayCenturion” for clay formation control; NF 201T™ for bitumen sticking control as well as control of foaming and bitumen dispersion into the drilling fluid; bactericide (25% glutaraldehyde) for bacteria contamination control; sodium bicarbonate for cement contamination control; lost circulation material to combat lost circulation; and/or defoamer (2-ethylhexanol) to control foaming due to rig personnel mistake in mixing of the additives.

Concentrations of each of the above additives may vary widely depending on the working conditions. The approximate concentrations of these additives are as follows: xanthan gum, about 3.5-5.5 kg/m³; modified starch, about 4-6 kg/m³; PAC, about 0.5-1.5 kg/m³; calcium carbonate, about 60-80 kg/m³; pH was maintained below 7 using sulphamic acid; and drilled solids and bitumen laced solids, about 2.0-5% by volume. Other concentrations were measured directly as outlined below.

When running the system during the top hole section, the xanthan gum, PAC and modified starch were premix in water at the above concentrations prior to drilling surface shoe and recycled fluid from a previous well was utilized in order to have enough volume. Once these polymers were hydrated “ClayCenturion” level was increased to 6 l/m³. The surface shoe was drilled out with additions of sodium bicarbonate to treat the cement. Once through the shoe calcium carbonate was added at the above concentration. The NF 201™ was first pre-hydrated in water in a pre-mix tank at a concentration of about 12 kg/m³. While drilling ahead the pre-mix was added at a rate of about 12-15 l/minute to the active system until the concentration listed above was reached. The NF 201™ concentration was maintained by adding the pre-mix as determined from the field test.

Positive results were obtained drilling through the bitumen with no bitumen sticking to shaker screens as can be seen from photographs of the shaker screens (Photographs 1 and 2). The fluid also maintained the clean grey appearance instead of brown dirty oily look which is indicative of free bitumen. There was sight oil gathered on top of the tanks 1 m in radius from the agitators stems on the fluid surface this may be due to some lighter oil separating from the fluid. The overall concentration was negligible. The NF 201™ also mixed with ease in a pre-mix tank.

The main fluid properties maintained through the bitumen rich formation was as follows: NF 201™, about 1.0 to 2.2 kg/m³ determined from field measure test; pH of about 6.2-8.0 from electronic pH meter (two decimal points); American Petroleum Institute fluid loss using PAC and modified starch, about 10.4-11.6 cc/30 minute; “ClayCenturion”, about 1.2-1.6 litres/m³ determine from field test; yield point using xanthan gum, PAC and modified starch, about 9-14 Pa.

### Example 8

A field application using NF 201™ was carried out on two wells located in Northern Alberta, Canada. A 17 meter of bitumen formation was penetrated in these wells. Formation was penetrated in one of these wells and bitumen was encountered. The fluid was run at similar concentrations with the exception only modified starch was used for fluid loss control. Similar methodology as in Example 7 was used to mix and maintain fluid properties.

On this particular drilling operation the following additives were used; Kelzari XCD™ (xanthan gum) for viscosity control; sulphamic acid for pH control; modified starch for fluid loss control; “ClayCenturion” for clay formation; NF 201™ for bitumen sticking control and control of foaming and bitumen dispersion into the drilling fluid; and bactericide for bacteria contamination control.

As in Example 7 positive results were obtained drilling through the bitumen without bitumen sticking to the tubular and shale shakers. The NF 201™ mixed well in a pre-mix tank at similar concentrations and methodology as in Example 7.

The fluid properties maintained through the bitumen rich formation was as follows: NF 201™, about 1.2 to 1.7 kg/m³ determined from field test; pH of about 6.5-10 from electronic pH meter (two decimal points) using sulphamic acid; American Petroleum Institute fluid loss using modified starch, about 7.8-14.2 cc/30 minutes; “ClayCenturion”, about 1.2-2.6 litres/m³ determined from field test; and yield point using xanthan gum and modified starch, about 5.5-14 Pa.

TABLE 1
Hot rolled at 110 F. for 2 hours.

| | | | | TAR- | |
|---|---|---|---|---|---|
| Sample | | POLYMER | WATER | SANDS | |
| # | POLYMER | (grams) | (ml) | (15%) | pH |
| 1 | DF 2020D | 3.5 | 350 | 52.5 | 2.5 |
| 2 | AF 102 | 3.5 | 350 | 52.5 | 2.5 |
| 3 | NF 201 | 3.5 | 350 | 52.5 | 2.5 |
| 4 | AE 143 | 8 | 350 | 52.5 | 2.5 |
| 5 | AF 250 | 3.5 | 350 | 52.5 | 3 |

TABLE 2
Hot rolled at 110 F. for 1.75 hours.

| | | | | TAR- | |
|---|---|---|---|---|---|
| Sample | | POLYMER | WATER | SANDS | |
| # | POLYMER | (grams) | (ml) | (15%) | pH |
| 1 | AF 204RD | 3.5 | 350 | 52.5 | 2.5 |
| 2 | AF 247RD | 3.5 | 350 | 52.5 | 2.5 |
| 3 | NF 201 | 3.5 | 350 | 52.5 | 4.49 |
| 4 | NF 201 | 3.5 | 350 | 52.5 | 5.51 |
| 5 | NF 201 | 2 | 350 | 52.5 | 2.5 |

TABLE 3
Hott rolled at 110 F. for 2 hours.

| | | | | TAR- | |
|---|---|---|---|---|---|
| Sample | | POLYMER | WATER | SANDS | |
| # | POLYMER | (grams) | (ml) | (15%) | pH |
| 1 | NF 201 | 1 | 350 | 52.5 | 5.5 |
| 2 | NF 201 | 1 | 350 | 52.5 | 5.5 |
| 3 | NF 201 | 1.9 | 350 | 52.5 | 5.5 |
| 4 | NF 201 | 1 | 350 | | 5.5 |
| | Kelzan XCD | 5 | | | |

| | SAMPLE | SAMPLE |
|---|---|---|
| VISCOSITY | 4 BHR | 4 BHR |
| 600 | 38 | 70 |
| 300 | 26 | 54 |
| 200 | 20 | — |
| 100 | 14 | — |
| 6 | 3 | 18.5 |
| 3 | 2 | 16 |
| 10″ | 1.5 | — |

TABLE 4
Hot rolled at 110 F. for 13 hours and 16 minutes.

| | | | | TAR- | |
|---|---|---|---|---|---|
| Sample | | POLYMER | WATER | SANDS | |
| # | POLYMER | (grams) | (ml) | (15%) | pH |
| 1 | NF 201 | 2 | 350 | | 4.5 |
| | KELZAN XCD | 1.8 | | | |
| 2 | NF 201 | 2 | 350 | 52.5 | 4.95 |
| | KELZAN XCD | 1.8 | | | |
| 3 | NF 201 | 1 | 350 | 52.5 | 4.49 |
| | KELZAN XCD | 1.75 | | | |
| 4 | NF 201 | 2 | 350 | 52.5 | 5.8 |
| 5 | Cationic | 2 | 350 | 52.5 | 6.2 |
| | Poly- | | | | |
| | acralamide | | | | |

| | SAM- | SAM- | SAM- | SAM- | SAM- | SAM- |
|---|---|---|---|---|---|---|
| | PLE | PLE | PLE | PLE | PLE | PLE |
| VISCOSITY | 1 BHR | 1 AHR | 2 BHR | 2 AHR | 3 BHR | 3 AHR |
| 600 | 50 | 86 | 59 | 59 | 41 | 50 |
| 300 | 35 | 66 | 42.5 | 49 | 29 | 44 |
| 200 | 26.5 | 55 | 33.5 | 46 | 23 | 34 |
| 100 | 18 | 46 | 23 | 36 | 16 | 15 |
| 6 | 3 | 20 | 4.5 | 15 | 3 | 14 |
| 3 | 2 | 17 | 3 | 14 | 2.5 | 14 |
| 10″ | 1.5 | 9 | 1.5 | 7 | 1.5 | 7 |

AHR: after hot rolling
BHR: before hot rolling

TABLE 5
Hot rolled at 115 F. for 2 hours.

| | | | | TAR- | | |
|---|---|---|---|---|---|---|
| Sample | | POLYMER | WATER | SANDS | | pH |
| # | POLYMER | (GRAMS) | (ml) | (12%) | pH | AHR |
| 1 | NF201 | 1.05 | 350 | 42 | 8 | 8 |
| 2 | NF201 | 1.05 | 350 | 42 | 7 | 7 |
| 3 | NF201 | 1.05 | 350 | 42 | 6 | 7 |
| 4 | NF201 | 1.05 | 350 | 42 | 4 | 5.5 |

TABLE 6
Hot rolled for 1.5 hours at 115 F.

| | | | | TAR- | | |
|---|---|---|---|---|---|---|
| Sample | | POLYMER | WATER | SANDS | | pH |
| # | POLYMER | (grams) | (ml) | (14.8%) | pH | AHR |
| 1 | NF 201 | 1.05 | 350 | 52 | 9 | 10 |
| | KCl | 3% (wt.) | | | | |
| 2 | NF 201 | 1.05 | 350 | 42 | 9 | 11 |
| | K₂SO₄ | 3% (wt.) | | | | |
| 3 | NF 201 | 1.05 | 350 | 42 | 9 | 9 |
| | ClayCenturion | 5 | | | | |

TABLE 7

| | | | | Competion | Competion | Competion | Competion |
|---|---|---|---|---|---|---|---|
| Hychem | | Molecular Weight | Charge | Equivalent - | Equivalent - | Equivalent - | Equivalent - |
| Polymer | Polymer Type | (millions) | % | CIBA | Cytec | Nalco | Kelco |
| NF-201 | Non-Ionic/Polyacrylamide | 10 | 0 | Alcomer 80 | CYDRILL/CYFLOC 4500 | | MF 1 |
| DF2020 | Anionic/Polyacrylate | very low <200K | 100 | 74L | Cygaurd | | |
| | | (~100,000) | | | | | |
| AF102 | Anionic/PHPA | 8-10 | 5 | | | | |
| AE143 | Anionic/Polyaclamide | 8 | 20 | | | | |
| AF250 | Anionic/Polyacrylate | 0.5 | 70 | 507 | Cypan | | |
| AF204RD | Anionic/PHPA | 10 | 15 | 338RD | | | |
| AF247RD | Anionic/PHPA | 4 to 5 | 30 | 60RD | | | |
| AF203 | Anionic/PHPA | 10 | 5 | | | | |
| AF204 | Anionic/PHPA | 10 | 10 | | CYDRILL/CYFLOC 4010, 4020 | | |
| AF207 | Anionic/PHPA | 10 | 30 | 110, 120 | CYDRILL/CYFLOC 4000, 4001 | | |
| AF207RD | Anionic/PHPA | 10 | 30 | 110RD | | | |
| AF211 | Anionic/Polyacrylate | 10 | 100 | 180 | Cyex | | |
| AF215 | Anionic/Polyacrylate | 10 | 95 | | | | |
| AF251 | Anionic/Polyacrylate | 0.5 | 100 | 1771 | | | Benex |
| AF308 | Anionic/PHPA | 15 | 40 | | | | |
| AF308HH | Anionic/PHPA | 20 | 20 | | | | |
| NE 823 | Non-Ionic/Polyacrylamide | 15 | 0 | | CYDRILL/CYFLOC 5500 | | |
| AE 833 | Anionic/PHPA | 15 | 5 | 80L | | ASP 715 | MF 55 |
| AE 843 | Anionic/PHPA | 15 | 10 | 90L | CYDRILL/CYFLOC 5200, 5310 | ASP 720 | |
| AE 853 | Anionic/PHPA | 15 | 30 | 123L | CYDRILL/CYFLOC 5300 | ASP 700 | |
| AE 856 | Anionic/PHPA | 10 | 30 | | CYDRILL/CYFLOC 5303 | | |
| AD 855 | Anionic/PHPA | 15 | 30 | 120L/OS | | | |
| AD 859 | Anionic/PHPA | 15 | 30 | 120L | | | |
| AE 874 | Anionic/PHPA | 15 | 40 | | | | |
| AE 876 | Anionic/PHPA | 15 | 50 | | | | |
| DF 2010 | Anionic/Polyacrylate | very low <200K | 40 | 72L | Cytemp | | |
| | | (~100,000) | | | | | |
| DF 2020D | Anionic/Polyacrylate | very low <200K | 40 | 74L | | | |
| | | (~100,000) | | | | | |

1-38. (canceled)

39. A water-based drilling fluid comprising an anionic polyacrylamide polymer.

40. A water-based drilling fluid according to claim 39, wherein the anionic polyacrylamide has a general formula 3 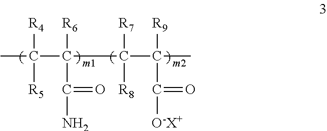
wherein: R₄ to R₉ are each independently selected from H and a C₁ to C₆ linear, branched, saturated, unsaturated or cyclic alkyl group optionally containing at least one heteroatom; and
m1 and m2 each independently range from 10,000 to 1,000,000; and
X⁺ is selected from the group consisting of Li⁺, Na⁺, K⁺ and a quaternary ammonium ion.

41. A water-based drilling fluid according to claim 39, wherein the anionic polyacrylamide is of formula 4: 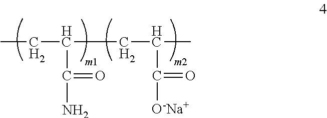
wherein: m1 and m2 each independently range from 10,000 to 1,000,000.

42. A water-based drilling fluid according to claim 39, wherein the fluid has a pH of about 8 or lower.

43. A water-based drilling fluid according to claim 39, wherein the fluid has a pH from about 5 to about 7.

44. A water-based drilling fluid according to claim 39, wherein the anionic polyacrylamide has an anionicity between 0 to 100%.

45. A water-based drilling fluid according to claim 39, wherein the anionic polyacrylamide has a molecular weight from about 8 to about 10 million.

46. A water-based drilling fluid according to claim 39 further comprising a compound selected from the group consisting of organic acid, inorganic acid, organic salt, inorganic salt and mixtures thereof.

47. A water-based drilling fluid according to claim 39 further comprising a compound selected from the group consisting of fluid additives, viscosifiers, fluid loss additives, weighting materials, clay formation control agents, bactericides, defoamers, lost circulation materials, bridging agents and mixtures thereof.

48. A method of drilling subterranean formations containing heavy crude oil or bitumen, the method comprising the steps of:
operating a drilling rig to drill a wellbore in a formation, the formation containing heavy crude or bitumen;
circulating a water-based drilling fluid to the drill bit operation of the drilling rig, the water-based drilling fluid comprising an anionic polyacrylamide polymer; and
maintaining the pH of the circulating drilling fluid below about 8.

49. A method according to claim 48, wherein the pH of the circulating drilling fluid is maintained between from about 5 to about 7.

50. A method according to claim 48, wherein the anionic polyacrylamide has a general formula 3: 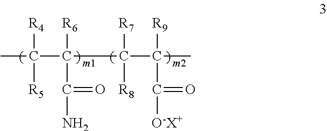
wherein R₄ to R₉ are each independently selected from H and a C₁ to C₆ linear, branched, saturated, unsaturated or cyclic alkyl group optionally containing at least one heteroatom; and
m1 and m2 each independently range from 10,000 to 1,000,000; and
X⁺ is selected from the group consisting of Li⁺, Na⁺, K⁺ and a quaternary ammonium ion.

51. A method according to claim 48, wherein the anionic polyacrylamide is of formula 4: 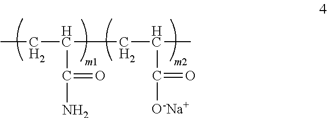
wherein m1 and m2 each independently range from 10,000 to 1,000,000.

52. A method according to claim 48, wherein the anionic polyacrylamide has an anionicity of between 0 and 100.

53. A method according to claim 48, wherein the polyacrylamide has a molecular weight of between about 8 million and about 10 million.

54. A method according to claim 48, wherein the drilling fluid further comprises a compound selected from the group consisting of organic acid, inorganic acid, organic salt, inorganic salt and mixtures thereof.

55. A method according to claim 48, wherein the drilling fluid further comprises a compound selected from the group consisting of fluid additives, viscosifiers, fluid loss additives, weighting materials, clay formation control agents, bactericides, defoamers, lost circulation materials, bridging agents and mixtures thereof.

56. A method as in claim 48, wherein the step of maintaining the pH of the circulating drilling fluid below 8 comprises addition of sulphamic acid to the drilling fluid.

57. A method as in claim 48, wherein the polyacrylamide polymer has an anionicity of less than about 1%.

58. A method as in claim 48, wherein the polyacrylamide polymer is present in the drilling fluid at a concentration of less than 4.5 kg/m³.

59. A method as in claim 48, wherein the polyacrylamide polymer is present in the drilling fluid at a concentration between about 0.5 kg/m³ and about 2.2 kg/m³.

60. A method as in claim 48, wherein bentonite is not present in significant quantities in the drilling fluid.
